(19) United States
(12) Patent Application Publication
(10) Pub. No.: US 2010/0209071 A1
(43) Pub. Date: Aug. 19, 2010

(54) APPARATUS AND METHOD FOR GENERATING STILL CUT FRAMES

(75) Inventor: Tae Hun CHO, Seoul (KR)

Correspondence Address: LRK Patent Law Firm, 1952 Gallows Rd, Suite 200, Vienna, VA, 22182, US

(73) Assignee: C&S TECHNOLOGY CO., LTD., SEOUL (KR)

(21) Appl. No.: 12/187,352

(22) Filed: Aug. 6, 2008

(30) Foreign Application Priority Data
Aug. 8, 2007 (KR) 10-2007-0079559

(51) Int. Cl. H04N 5/91

(52) U.S. Cl. 386/68; 386/E05.003

(57) ABSTRACT

An apparatus and method for generating still cut frames from video frames that are executed consecutively includes a storage unit for temporarily storing specific ones of the executed video frames in real-time, a display unit for displaying the video frames, and a controller for controlling the storage unit and the display unit in response to an external input signal. When a still cut command signal is input as the external input signal, the controller controls the video frames, are temporarily stored in the storage unit, to be decided and the decided video frames to be displayed through the display unit. When a signal selecting a specific one of the displayed frames is input, the controller generates the selected frame as a still cut frame.

### CROSS-REFERENCE TO RELATED APPLICATION

The benefit of priority is claimed to Republic of Korea patent application number 10-2007-0079559, filed Aug. 8, 2007, which is incorporated by reference herein.

### INTRODUCTION

The present invention relates to an apparatus and method, in which a user can select a still image, which is the closest to an image which he or she desires to capture, from consecutively displayed images, and capture the selected image.

### BACKGROUND

In the prior art, in order to capture a specific one of displayed images, a structure is generally used in which a user's capturing request is input through an external input device, such as a keypad, and a specific frame is then selected and stored using an additional program.

The conventional method has a structure of determining the time point when an image is captured on the basis of an external input. This method generally has a high probability that a scene different from a scene, which a user actually desires to capture, will be captured. The reason for this is because a time lag occurs between the time taken for a process in which a user actually instructs an external input after recognizing an image and the time taken for a system to process the external input, such that real-time images are continuously processed during the time lag.

FIG. 1 illustrates an example of the above problem, which is represented on the basis of the time axis. Although a user wants to capture an image (a first target image), which appears at a time point T1, the time is taken for the user to set an external input and the time is also taken for a system to finally store an image. Therefore, an image at a time point T3 or T4, but not at the time point T1, can be finally selected. Consequently, an image different from the first target image can be captured.

Accordingly, there has been a need for a technique that allows the user can select an image which is the closest to a first target image to thereby satisfy a user's requirement.

### SUMMARY

Accordingly, the present invention has been made in view of the above problems occurring in the prior art, and it is an object of the present invention to provide an apparatus and method, wherein the past images anterior to an image at a present time point are continuously stored, and the past images anterior to a Time point when a capturing execution signal, which was stored when a user wanted to capture a specific image, was input are sequentially output so that the user can select the specific image from the output images.

To achieve the above object, according to the present invention, there is provided an apparatus for generating still cut frames from video frames that are executed consecutively, the apparatus, including a storage unit for temporarily storing specific ones of the executed video frames in real-time, a display unit for displaying the video frames, and a controller for controlling the storage unit and the display unit in response to an external input signal. When a still cut command signal is input as the external input signal, the controller controls the video frames, are temporarily stored in the storage unit, to be decided and the decided video frames to be displayed through the display unit. When a signal selecting a specific one of the displayed frames is input, the controller generates the selected frame as a still cut frame.

The frames stored in the storage unit keep remained at the same storage positions until the frames are deleted.

The storage unit updatingly stores a new frame at a position where the oldest frame of the stored frames had been stored.

Further, a method of generating still cut frames from video frames that are executed consecutively includes a first step of temporarily storing specific ones of the executed video frames in real-time, a second step of, when a still cut command signal is input, deciding the specific frames, which are temporarily stored in the first step, a third step of displaying the frames decided in the second step, and a fourth step of selecting any one of the displayed frames.

### BRIEF DESCRIPTION OF THE DRAWINGS

Further objects and advantages of the invention can be more fully understood from the following detailed description taken in conjunction with the accompanying drawings in which:

FIG. 1 is a diagram showing a time lag between a scene which a user wants and a scene processed in an apparatus in the prior art;

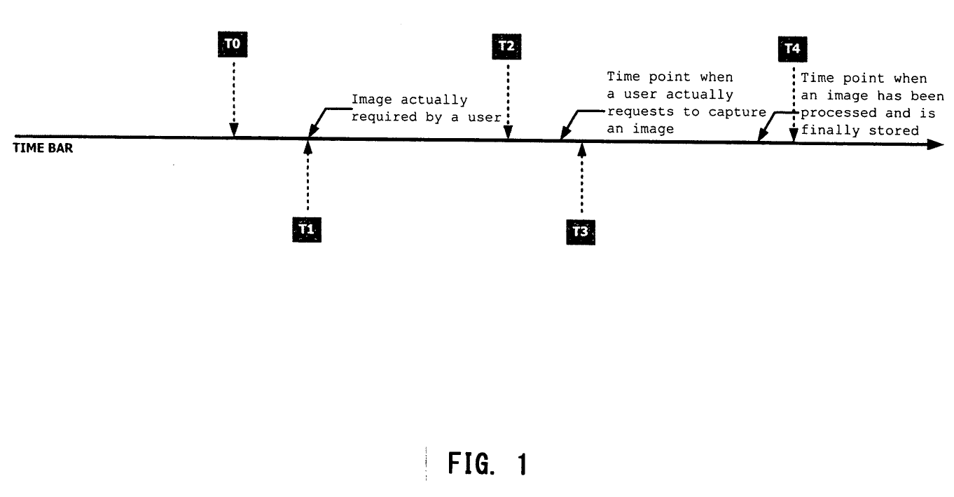

FIG. 2 is a diagram showing the basic operation of an apparatus for generating still cut frames in accordance with an embodiment of the present invention;

FIG. 3 is a block diagram of the apparatus for generating still cut frames in accordance with an embodiment of the present invention;

FIG. 4 is a flowchart illustrating an operation for continuously storing present images in a frame storage unit;

FIG. 5 is a diagram showing an example of a method of storing video frames;

FIG. 6 is a flowchart illustrating a method of capturing a target video at the request of a user;

FIG. 7 is a diagram showing an example in which images of stored frames are configured in a row on the basis of the time axis in order to describe preview video setting;

FIG. 8 is a diagram showing an example of a preview screen configuration output to a screen output unit in accordance with an embodiment of the present invention;

FIG. 9 is a diagram showing another example of a preview screen configuration output to the screen output unit in accordance with an embodiment of the present invention; and

FIG. 10 is a diagram showing still another example of a preview screen configuration output to the screen output unit in accordance with an embodiment of the present invention.

### DETAILED DESCRIPTION

The present invention will now be described in detail by way of specific example embodiments with reference to the accompanying drawings.

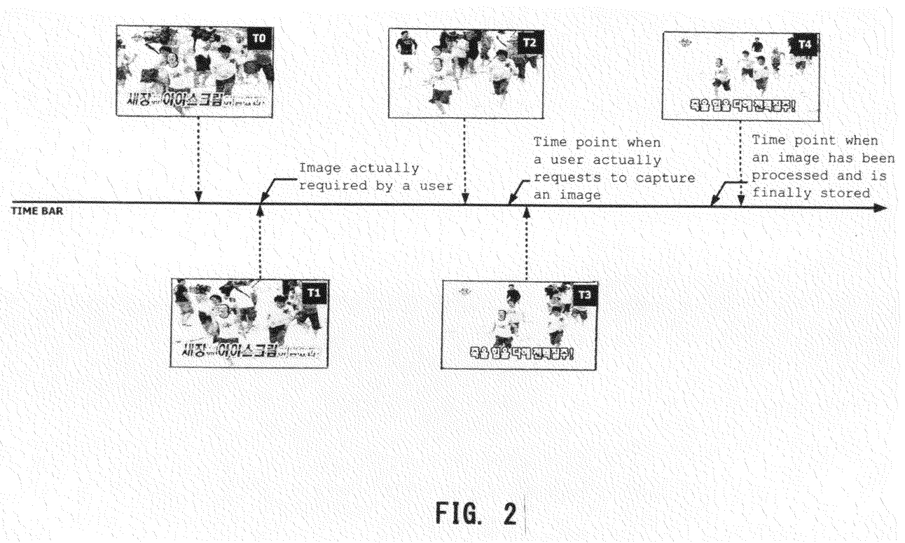

FIG. 2 is a view illustrating the basic operation of an apparatus for generating still cut frames in accordance with an embodiment of the present invention.

An abscissa axis indicates the flow of the time. In the abscissa axis, the time is close to a present time as it elapses from the left to the right. That is, the abscissa axis indicates the flow of the time in order of T0, T1, T2, T3, and T4.

A problem arises in a process in which a user tries to capture a first target image while watching displayed images. In other words, the user wants to capture an image at a time point T1 (the first target image). However, the time is taken for the user to input a capturing command using a keypad, a touch screen, etc. after recognizing the first target image, and the time is also taken for a system to process the user's capturing command. Accordingly, there is a high probability that an image different from the first target image can be selected and captured because the capturing command is executed not at the first time point T1, but between time points T3 and T4.

In the present invention, in order to minimize this problem, a system displays (the past) still images at time points T0, T1, T2, T3, which are anterior to a Time point when a user's request is finally received, so that the user can select a desired still image. Accordingly, the user can obtain an image that is the closest to the first target image.

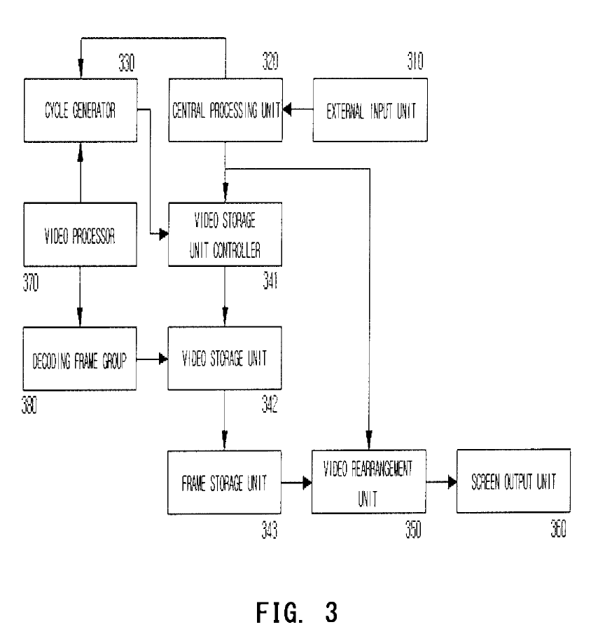

FIG. 3 is a block diagram of the still cut frame generating apparatus in accordance with an embodiment of the present invention.

An external input unit 310 is adapted to receive a user input signal and transfer the signal to a central processing unit 320. The external input unit can include a keyboard, a touch screen or the like.

The central processing unit 320 analyzes a user's command received from the external input unit 310 and controls each constituent element to execute a corresponding operation.

That is, the central processing unit 320 transfers a control signal to a video storage unit controller 341 for storing video frames and a cycle generator 330 for generating a storage cycle of an image based on command information analyzed in the central processing unit 320.

The cycle generator 330 generates a video storage cycle signal on the basis of a set time received from the central processing unit 320 and transmits the generated video storage cycle signal to the video storage unit controller 341. Here, a sync signal to synchronize the cycle generator is activated based on a frame processing finish signal of a video processor 370 or a clock provided from an external cycle generator.

A candidate video frame storage unit 340 includes the video storage unit controller 341, a video storage unit 342 and a frame storage unit 343. The candidate video frame storage unit 340 stores candidate video frames. The candidate video frames will be displayed on a screen output unit 360 and may be objects, which a user desires to capture.

The video storage unit controller 341 controls the video storage unit 342 and manages storage positions where candidate video frames are stored.

The video storage unit 342 selects a specific frame from a decoding frame group processed by the video processor 370 and stores the selected frame in the frame storage unit 343.

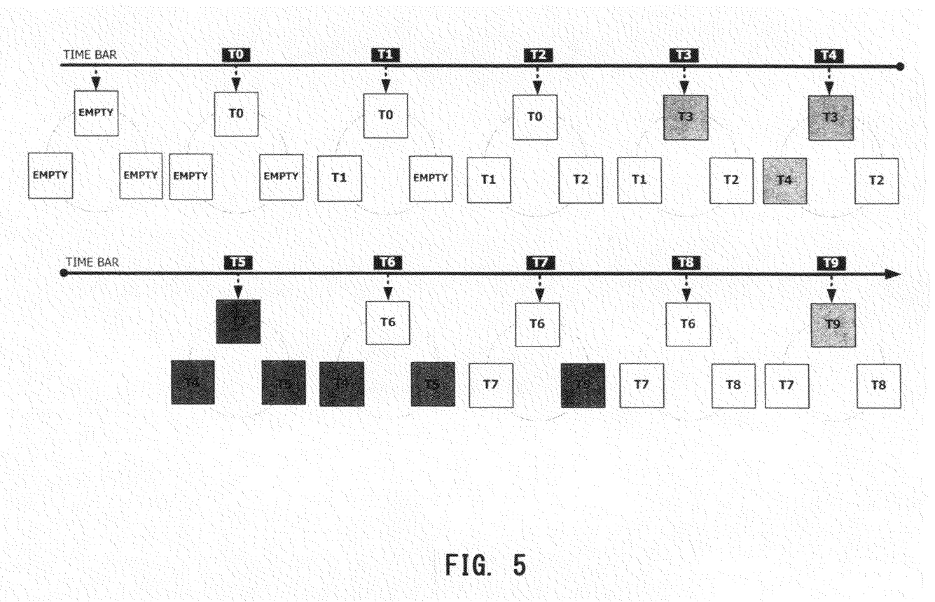

The frame storage unit 343 stores candidate video frames that can be selected by a user. The number of video frames stored in the frame storage unit is finite, and a detailed description thereof is given with reference to FIG. 5.

A video rearrangement unit 350 functions to reconfigure images of candidate video frames in order to process a preview function of images from a present time point to a past time point at the request of the central processing unit 320 and provides the processed video information to the screen output unit 360.

The screen output unit 360 displays images of candidate video frames, which are received from the video rearrangement unit 350. The video rearrangement unit and the screen output unit can be integrated into one display unit.

The video processor 370 processes a specific video object, and a decoding frame group 380 refers to a frame group of a specific processed video object.

The present invention can largely include a process of continuously storing present images in temporary spaces on the basis of a time set by a user or the video processor, and a process of selecting a preview operation of images, which were stored in the past, and a last target image when a capturing request is received from a user. The two processes are independently performed according to an application program.

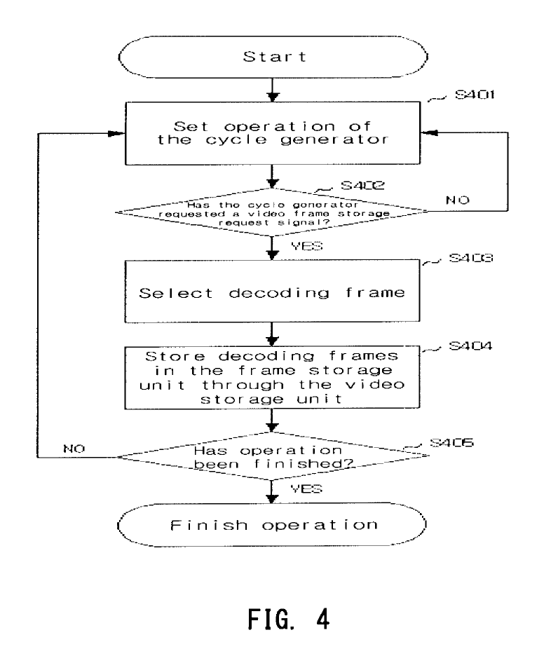

FIG. 4 is a flowchart illustrating an operation for continuously storing present images in the frame storage unit.

1. An application is driven in response to a control signal of the central processing unit, which is generated based on a command input to the external input unit.

2. Operating environment of the cycle generator 330 is set (S401). Here, a user can set a cycle to have a constant cycle. Further, a sync signal of the cycle generator is generated in response to an image process completion signal, which is received from the video processor 370, or an external clock source according to a user' setting.

3. When the cycle generator 330 generates a video frame storage request signal according to the constant cycle (S402), the video storage unit 342 selects decoding frames processed in the video processor according to the control signal of the video storage unit controller 341 (S403).

4. The decoding frames selected by the video storage unit 342 are stored in the frame storage unit 343 (S404). Here, the decoded video information can be stored without any separate process or can be compressed and stored using a method set by a user.

5. When a user generates an operation finish request signal, the operation is finished. When any operation finish request is not made, the process enters a cycle generator operating setting mode in which present images of a decoding frame group are continuously stored in the frame storage unit 343 on the basis of a video frame storage request of the cycle generator (S405).

FIG. 5 is a diagram showing an example of a method of storing video frames.

Space where video frames can be actually stored in the frame storage unit 343 is finite, making it impossible to permanently store the video frames. Thus, the frame storage unit 343 has a structure in which only images anterior to a certain time point from a present time can be stored.

FIG. 5 shows an example in which three frames can be stored as the time elapses from T0 to T9.

Initially, the entire storage elements are empty and are stored in an order in which a corresponding frame is stored counterclockwise according the flow of the time points T0, T1, T2, . . . At the time point T3, a T0 frame, which was stored for the first time, is deleted, and a T3 frame is stored at a position where the TO frame was deleted. That is, a method of storing a present frame is to update and store a present frame at a storage element in which the oldest frame at a present state is stored. Further, a frame that was stored once keeps stored until the frame is deleted from a storage element in which the frame was stored for the first time.

In the present invention, video frames are continuously stored in finite temporary spaces on the basis of the time axis without being limited to the number of storage elements or a storage control method.

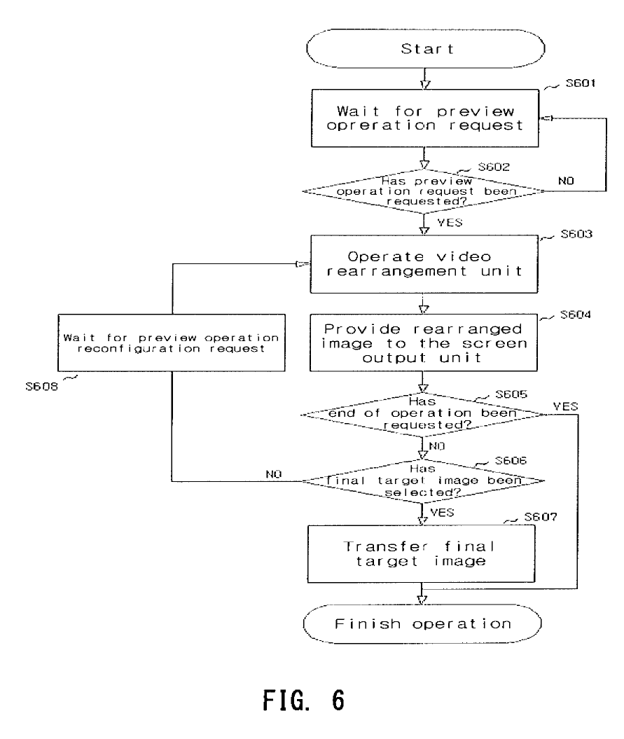

FIG. 6 is a flowchart illustrating a method of capturing a target video at the request of a user.

FIG. 6 illustrates a method of setting the preview of images, rearranging the images according to a user's intention, and finally selecting a specific image. Processes of the method are described below.

1. An application is driven and then waits for a request for a preview operation (S601).

2. When a capturing request by a user to select a first target video is input to the central processing unit 320 through the external input unit 310 (S602), the central processing unit 320 instructs the video storage unit controller 341 to finish the operation, changes and stores storage positions of regions where candidate video frames are stored temporarily and other regions so as to store frames stored up to now, that is, stored frame, and restarts the process of FIG. 4.

At the same time, the central processing unit 320 controls the video rearrangement unit 350 (S603) to read the stored frames, configures a preview screen and then output the configure preview screen to the screen output unit 360 (S604).

3. When an finish request is generated to the preview operation from a user (S605), the operation finish mode is entered and the operation is finished.

When there is no operation finish request from a user, the process is changed according to whether a target video is selected or not.

4. After the user selects the target image (S606), the central processing unit 320 provides an address of the video frame selected from the stored frames to an external processor or the video processor or stores the selected image in an additional storage device, and enters the last operation finish mode (S607).

5. Here, when there is no target image in the preview screen, the central processing unit 320 changes setting of the video rearrangement unit 350 and then changes the configuration of an image output to the external input unit 310 according to a request to reconfigure the received preview, selects the target image, and waits for an image reconfiguration request until an operation finish request is generated or operated according to the user's intention (S608).

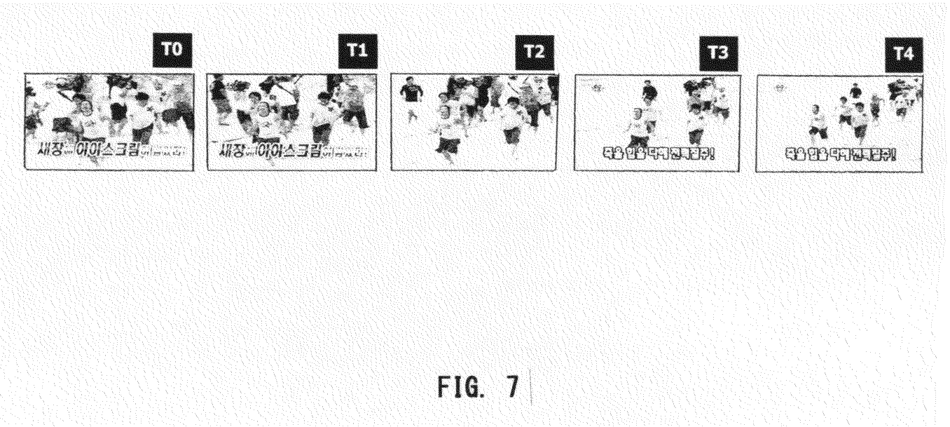

FIG. 7 is a diagram showing an example in which images of stored frames are configured in a row on the basis of the time axis in order to describe preview video setting.

A part or all of the stored frames is configured by the video rearrangement unit 350 and output through the screen output unit 360.

That is, in case where up to three images are output at once through the screen output unit 360, the three images are output, and the remaining images can also be configured and output according to a user's selection. In other words, three images stored at a time point anterior or posterior to a specific time point can be output as a set, or images being temporally adjacent to the output three images can be output sequentially one by one.

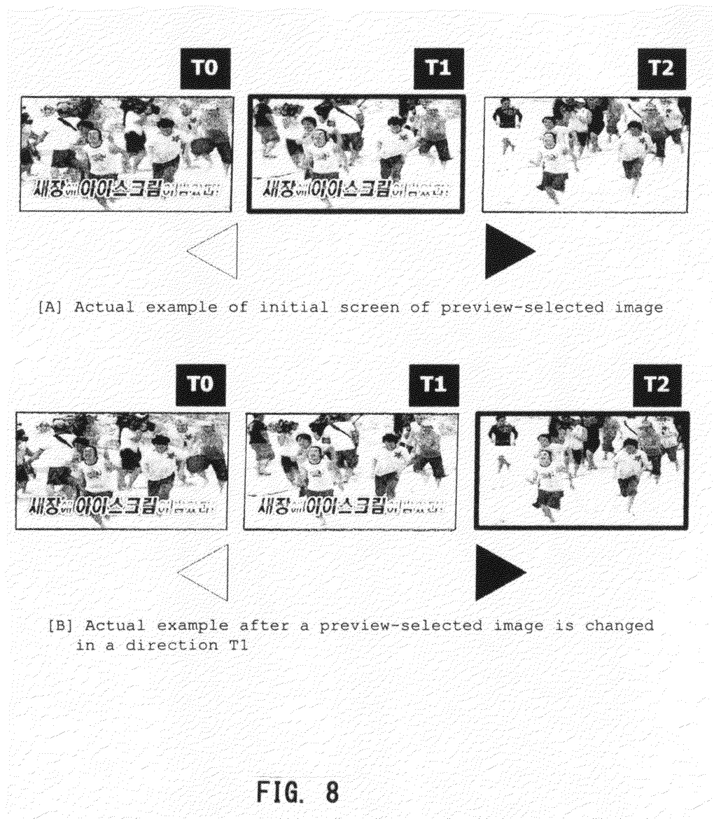

FIGS. 8 to 10 are diagrams showing examples of preview screen configurations output to the screen output unit in accordance with embodiments of the present invention.

FIG. 8 shows a configuration in which an image that is expected to be selected next is framed differently from surrounding images.

If images having the same size are displayed in order of the past time or the present time according to the elapse of the time and a user is designated to select one of the images and the selected image, which is expected to be selected next, is framed and decided, the image is captured.

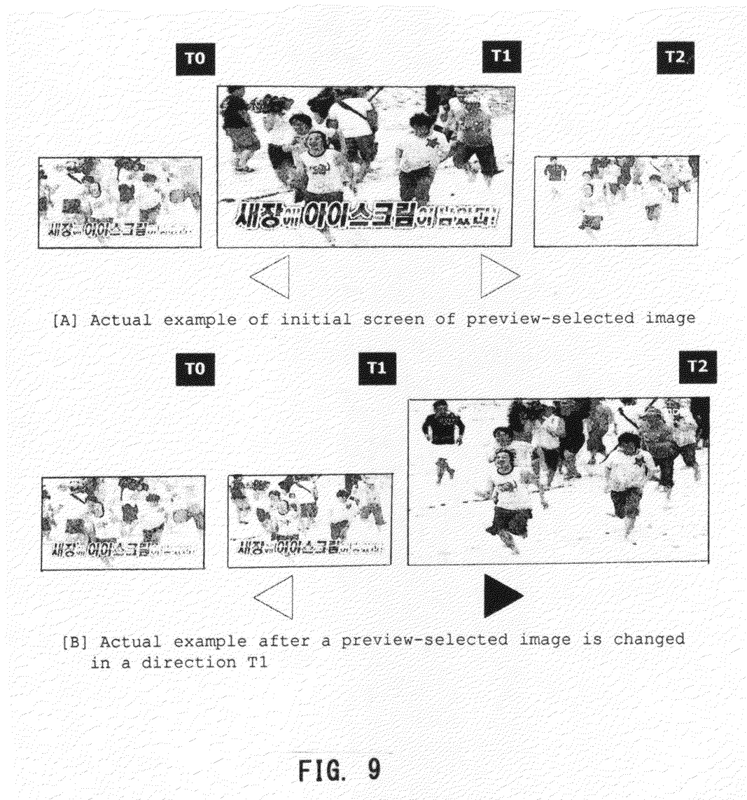

FIG. 9 shows a configuration in which an image that is expected to be selected next is set to be larger than surrounding images.

In this configuration, images are displayed in order of the past time or the present time according to the elapse of the time, and an image that is expected to be selected next is set to be larger than surrounding images or images other than the image that is expected to be selected next are set to be faint or dark as shown in FIG. 9.

When an image, which is expected to be selected next and is enlarged or brightened, is decided, the image is captured.

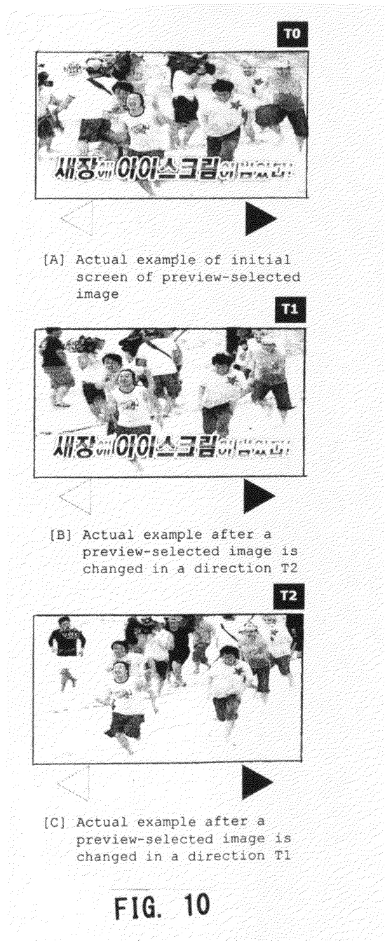

FIG. 10 shows a configuration in which one image is displayed.

When one image is displayed and decided, the image is captured.

In case where one image, which is displayed at this time, is not a target image, another image being temporally anterior or posterior to the displayed image is displayed according to a user's selection. Accordingly, when a desired object image is displayed and decided, the image is captured.

As described above, according to the present invention, still images, which are stored during a specific time period, of consecutive images processed in real-time, such as mobile TV or multimedia images, are provided, and one of the provided still images is captured. Accordingly, the present invention is advantageous in that a scene being the closest to a scene intended by a user can be captured.

Further, the present invention can be widely applied to various applications for extracting one still image using a real-time image.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An apparatus for generating still cut frames from video frames that are executed consecutively, the apparatus comprising:
a storage unit configured to temporarily store specific ones of the executed video frames in real-time;
a display unit configured to display the video frames; and
a controller configured to control the storage unit and the display unit in response to an external input signal, to control the video frames, temporarily stored in the storage unit, to be decided and the decided video frames to be displayed through the display unit when a still cut command signal is input as the external input signal, and to generate the selected frame as a still cut frame when a signal selecting a specific one of the displayed frames is input.

2. The apparatus as claimed in claim 1, wherein the storage unit stores the video frames in response to a cyclic signal generated on a basis of a set time.

3. The apparatus as claimed in claim 2, wherein the cyclic signal is synchronized with an image processing completion signal, which is generated from a processor that executes video frames, or an external specific clock signal.

4. The apparatus as claimed in claim 1, wherein the frames stored in the storage unit keep remained at the same storage positions until the frames are deleted.

5. The apparatus as claimed in claim 1, wherein the storage unit updatedly stores a new frame at a position where the oldest frame of the stored frames had been stored.

6. The apparatus as claimed in claim 1, wherein a plurality of the decided video frames are simultaneously displayed on one screen provided by the display unit.

7. The apparatus as claimed in claim 6, wherein, when one of the displayed video frames is expected to be selected, the selected video frame is framed.

8. The apparatus as claimed in claim 6, wherein, when one of the displayed video frames is expected to be selected, the selected video frame is displayed in a size different from that of other video frames.

9. The apparatus as claimed in claim 6, wherein, when one of the displayed video frames is expected to be selected, the selected video frame is displayed to have brightness different from that of other video frames.

10. The apparatus as claimed in claim 1, wherein one of the decided video frames is displayed on a screen provided by the display unit.

11. The apparatus as claimed in claim 6, wherein, in case where the display unit displays the video frames, when a screen reconfiguration input signal is input, the other screen displaying the other video frame is provided.

12. The apparatus as claimed in claim 10, wherein, in case where the display unit displays the video frames, when a screen reconfiguration input signal is input, the other screen displaying the other video frame is provided.

13. The apparatus as claimed in claim 1, wherein the video frames stored in the storage unit are stored without any separate process or compressed and stored.

14. The apparatus as claimed in claim 1, wherein the decided video frames are stored in a different region from a region where the video frames are stored temporarily and then kept remaining.

15. A method of generating still cut frames from video frames that are executed consecutively, the method comprising:
a first step of temporarily storing specific ones of the executed video frames in real-time;
a second step of deciding the specific frames, which are temporarily stored in the first step, when a still cut command signal is input;
a third step of displaying the frames decided in the second step; and
a fourth step of selecting any one of the displayed frames.

16. The method according to claim 15, wherein the first step, second step, third step and fourth step are executed in sequential order.

17. The method according to claim 15, further comprising:
performing the first step by a storage unit for temporarily storing specific ones of the executed video frames in real-time,
performing the third step by a display unit for displaying the video frames, and
performing the second and fourth steps by a controller for controlling the storage unit and the display unit in response to an external input signal, for controlling the video frames, temporarily stored in the storage unit, to be decided and the decided video frames to be displayed through the display unit when a still cut command signal is input as the external input signal, and for generating the selected frame as a still cut frame when a signal selecting a specific one of the displayed frames is input, and
providing the storage unit, the display unit and the controller in an apparatus for generating still cut frames from video frames that are executed consecutively.

18. An apparatus for generating still cut frames from video frames that are executed consecutively, the apparatus comprising:
first means for temporarily storing specific ones of the executed video frames in real-time;
second means for deciding the specific frames, which are temporarily stored in the first means, when a still cut command signal is input;
third means for displaying the frames decided in the second means; and
fourth means for selecting any one of the displayed frames.
